(19) United States
(12) Patent Application Publication
(10) Pub. No.: US 2003/0034585 A1
(43) Pub. Date: Feb. 20, 2003

(54) Stretching device and method of manufacturing stretched synthetic filaments

(76) Inventors: Engelbert Locher, Worms (DE); Helmut Leiner, Blieskastel (DE); Robert Groten, Sundhoffen (FR); Peter Dengel, Kaiserslautern (DE); George Riboulet, Colmar (FR)

Correspondence Address: KENYON & KENYON, ONE BROADWAY, NEW YORK, NY, 10004, US

(21) Appl. No.: 10/212,611

(22) Filed: Aug. 5, 2002

(30) Foreign Application Priority Data
Aug. 9, 2001 (DE) 101 39 228.1

(51) Int. Cl. B29C 47/60

(52) U.S. Cl. 264/210.8; 264/211.22; 425/72.2; 28/240

(57) ABSTRACT

A stretching device and method of manufacturing stretched synthetic filaments (2, 3) includes a spinning device (1) and a pneumatic drawing-off device (10). A heating device (5) is situated between the spinning device (1) and the drawing-off device (10) which heats the filaments (2, 3) to a temperature between their glass-transition temperature and their melting temperature.

### BACKGROUND OF THE INVENTION

1. Field of the Invention

The invention relates to a stretching device which includes a spinning device and a pneumatic drawing-off device, and to a method of manufacturing stretched synthetic filaments in which melt-spun filaments having an individual titer greater than 1 dTex are cooled at least to the solidification temperature downstream from a spinning device and are stretched using a pneumatic drawing-off device, for the manufacture of synthetic threads, staple fibers, or non-woven fabrics.

2. Description of Related Art

The manufacture of synthetic filaments by melt-spinning involves basically three process steps. First, the polymer is melted using an extruder, then the filaments are spun using a spinneret or multiple spinnerets provided with capillary bore holes. Finally, the spun filaments are stretched in order to reduce the cross-sectional area and to alter the mechanical properties of the synthetic filaments or fibers. The reduction of the cross-sectional area of the spun filament is an essential prerequisite for many technical and textile applications.

The filaments are stretched using a drawing-off device, either mechanically via galettes, or pneumatically via a nozzle.

Regardless of the type of integrated drawing-off device used, pneumatic or mechanical, the filaments spun on a single-stage system at a high spinning speed, i.e., greater than 3500 m/min, have distinctly poorer mechanical properties, such as tenacity and elastic modulus, than filaments spun at a lower spinning speed, i.e., less than 3500 m/min, which have undergone after-stretching in an additional process step.

Although a high spinning speed in the single-stage method favors the formation of improved mechanical properties compared to a lower spinning speed, at the same time structural differences in the filament itself between the surface and the interior of the filament are created which cause a reduction in the tenacity or elastic modulus of the filaments, compared to an after-stretched filament.

U.S. Pat. No. 2,604,667 teaches the manufacture of oriented threads, without a special stretching device for after-stretching, using a drawing-off speed of less than 4700 m/min. This high speed is necessary to achieve a high tenacity. If the speed falls below this value, the filaments produced have a high elongation. Driven rollers or an air nozzle may be used to achieve this drawing-off speed. U.S. Pat. No. 2,604,667 primarily deals with the manufacture of yarns, but the manufacture of staple fibers using an air nozzle as the drawing-off device is also mentioned, as well as the manufacture of spun non-woven fabrics from spun continuous filaments using a pneumatic nozzle in a drawing-off device operated in the sonic to ultrasonic range. In each case, a plurality of solidified filaments is supplied via the nozzle of a receiving device for the manufacture of the spun non-woven fabric. The force exerted by air friction on the filaments allows the drawing-off speed to be adjusted and thus the mechanical properties of the filaments to be influenced. It has been shown that the influence on the properties of the filaments is limited. In spite of an increase in the drawing-off speed, which occurs as a result of raising the pressure of the air supplied to the nozzle, it is hardly possible to further increase the tenacity or to further reduce the elongation.

A method is known from German Unexamined Patent Application 2 117 659 for the manufacture of threads and fibers by melt-spinning of capillaries made of synthetic linear polymers, the method operating at drawing-off speeds of up to 3500 m/min. The drawing-off speed is predetermined by the speed of a pair of galettes. To influence the elongation, a heating element is arranged between a spinneret and the drawing-off galettes which heats a synthetic thread having 50 filaments to temperatures above the solidification point and below the melting temperature, thereby achieving a drawing ratio of up to 1:2. The cited document also mentions the manufacture of spun non-woven fabrics from filaments having a fine individual titer and a specially adapted tenacity and elongation, but does not discuss this in more detail.

German Unexamined Patent Application 29 25 006 describes the effect that drawing has on the tenacity as well as on the elongation and shrinkage. It is stated therein that the filaments acquire a higher tenacity as the result of drawing, whereas the elongation and shrinkage are reduced. The spinning speeds of 4100 m/min to 6000 m/min, which are higher compared to those in German Unexamined Patent Application 2 117 659, are achieved by using a moderately red-hot heating element in direct contact with the filaments.

For the manufacture of synthetic fibers made of polymer, in particular polyamide, polyester, or polypropylene, by melt spinning, a system is known from German Patent 40 21 545 which has at least a spinneret, a blow shaft, a heating shaft, a preparation device, a galette device, and a winding device, the heating shaft having blowing devices such as blowing nozzles which produce counterflow. Fully stretched synthetic threads or fibers may be manufactured using this system, the individual fibers or filaments having an individual titer of less than 1 dTex. Using this system and this method, fully stretched synthetic threads are produced without aftertreatment, which may be processed into a particularly fine, flexible fabric. It is not discussed in the cited document whether the system has sufficient stretching properties to achieve higher titer ranges.

German Patent Application 197 05 113 describes a generic device and a method for producing stretched synthetic filaments in which the flow of a heating medium from a heating device heats the synthetic filaments in counterflow.

### SUMMARY OF THE INVENTION

It is an object of the invention to provide a device and a method for manufacturing stretched synthetic filaments which, compared to known devices and methods, allow a more compact construction with respect to the length of the heating device, and which are suitable for manufacturing stretched synthetic filaments having a titer greater than 1 dTex and for producing filaments having higher tenacity and reduced elongation.

These and other objects of the invention are achieved, according to one embodiment of the invention, by a stretching device which has a heating device situated between the spinning device and the drawing-off device in which a heating medium heats the synthetic filaments to a temperature between their glass-transition temperature and their melting temperature.

### BRIEF DESCRIPTION OF THE DRAWINGS

The present invention will be described in greater detail with reference to the following drawings wherein:

FIG. 1a shows the essential components of the system.

FIG. 1b shows an additional module having a different heating device.

FIG. 2 shows a curve of the speed of a filament bundle according to the present invention, compared to conventional systems.

FIG. 3 shows the characteristic curves for various mechanical properties.

### DETAILED DESCRIPTION OF THE INVENTION

In accordance with the invention, continuous filaments may be produced from thermoplastic synthetics such as polyester (PES), polyamide (PA), polypropylene (PP), and polyethylene (PE), among others, by single-stage or multi-stage spinning (two-layered, segmented, coaxial, and the like) for technical or textile applications. The mechanical properties of filaments produced by melt spinning are improved substantially, in particular for the same titer, with respect to tear strength, elongation behavior, elastic modulus, and thermal shrinkage of filaments and non-woven fabrics made from them.

The heating medium is preferably supplied to the heating device at a flow rate of 5 m³/hr to 50 m³/hr, and a static gauge pressure of 0.05 bar to 1.0 bar.

The stretching device advantageously has a heating device which is an infrared heating device.

The static gauge pressure in the stretching device according to the present invention is 0.1 bar to 0.5 bar.

Preferably, 5 m³/hr to 50 m³/hr steam is supplied as the heating medium to the stretching device.

The heating device may be operated using hot air or another hot, preferably neutral gas, or also gas mixtures containing additives, in particular steam. The air is heated to a temperature between the glass-transition temperature and the melting temperature of the filaments.

The stretching is defined by the difference between the entry speed of the filaments into the heating device and the entry speed of the filaments into the drawing-off device.

Surprisingly, it has been found that the result of the stretching is independent of the direction of flow of the heating medium.

In an advantageous refinement of the present invention, means may be provided for manufacturing a spun non-woven fabric. This means causes the synthetic filaments conveyed via the pneumatic drawing-off device to be deposited to form a flat structure, namely, a spun non-woven fabric, no further conveying means being necessary for the synthetic filaments. When the device and the method according to the present invention are used on segmented multifilaments, which preferably are subsequently separated or split into their elementary filaments using hydrodynamic treatment, the separation or splitting rate is surprisingly increased at the same energy input, or, rather, at the same separation or splitting rate of the multifilaments it is possible to reduce the required energy input. In addition, the length of the heating device may be shortened in comparison to the related art.

The stretching device may also be supplemented with means for producing staple fibers, the synthetic filaments being cut into short fibers. These fibers are particularly suited for the manufacture of non-woven fabrics.

The present invention further relates to a method of producing stretched synthetic filaments in which melt-spun filaments are cooled at least to the solidification temperature downstream from a spinning device, stretched using a pneumatic drawing-off device, and then heated in a heating device, the filaments for the purpose of stretching being heated in a heating device to a temperature between their glass-transition temperature and their melting temperature.

Preferably, following the method according to the present invention a gaseous heating medium heated to a temperature above the solidification point is blown onto the filaments in the heating device by, at a flow rate of 20 m³/hr to 50 m³/hr, which creates a static gauge pressure of 0.05 bar to 1.0 bar. The synthetic filaments thus acquire a higher tenacity at a lower elongation.

Heating is advantageously performed using an infrared heating device which is situated at right angles to the vertically moving filaments.

These filaments require no further after-stretching, and allow the method according to the present invention to be carried out at lower drawing-off speeds than previously known.

The method according to the present invention is preferably carried out in such a way that after-stretching occurs between the heating device and the drawing-off device at a stretching ratio of 1.1 to 1.5.

In addition, it is advantageous if the heating medium is blown onto the filaments in a temperature range between 100° C. and 350° C. The volumetric flow rate of the heating medium is between 5 m³/hr and 50 m³/hr steam.

To achieve a distinct improvement in tenacity and elongation, it is sufficient to guide the filaments through the heating medium stream at a drawing-off speed of 2000 m/min to 4700 m/min. However, the improvement in properties occurs at higher speeds as well.

The properties of the synthetic filaments to be manufactured may be influenced by the method according to the present invention. Thus, it is possible to adjust the quantity of the heating medium flow and its temperature so that a thread elongation of less than 60% is achieved, or to adjust the drawing-off speed of the filaments and the quantity of the heating medium flow and its temperature so that, at the same drawing-off speed, a relative increase in the tensile strength of the after-stretched filament of less than 20% is achieved, compared to a filament stretched in a single-stage process, a tensile strength of the filaments of at least 32 cN/Tex, particularly preferably 34 cN/Tex to 45 cN/Tex, being achieved, or to adjust the quantity of the heating medium flow and its temperature so that a maximum hot air shrinkage of 6% (at 180° C., 15 minutes) is achieved. This is particularly applicable if the material used is PES.

Furthermore, it is advantageous to adjust the drawing-off speed of the filaments and the volumetric flow rate of the heating medium and its temperature so that the transition from the region of elastic deformation to the region of plastic deformation does not occur until a force at least 20% higher is applied.

Although the filaments are highly stretched, it is possible after stretching to further after-stretch the filaments, continuously or in a separate treatment step.

As a further process step, the synthetic filaments may be deposited on a support for creating a non-woven fabric or cut for manufacturing staple fibers, it being possible to draw off the cut filaments for further processing.

It is particularly advantageous to use the synthetic filaments to manufacture a non-woven fabric, the filaments having a tensile strength of at least 32 cN/Tex and an elongation less than 60%. For manufacturing a spun non-woven fabric, it is possible to deposit the synthetic filaments as continuous threads, and, for manufacturing a non-woven fabric, to use the staple fibers obtained according to the method of the present invention.

It is also advantageous to use the synthetic filaments to manufacture yarns, the filaments having a tensile strength of at least 32 cN/Tex and an elongation less than 60%. The yarns may be produced from continuous synthetic filaments or spun from staple fibers.

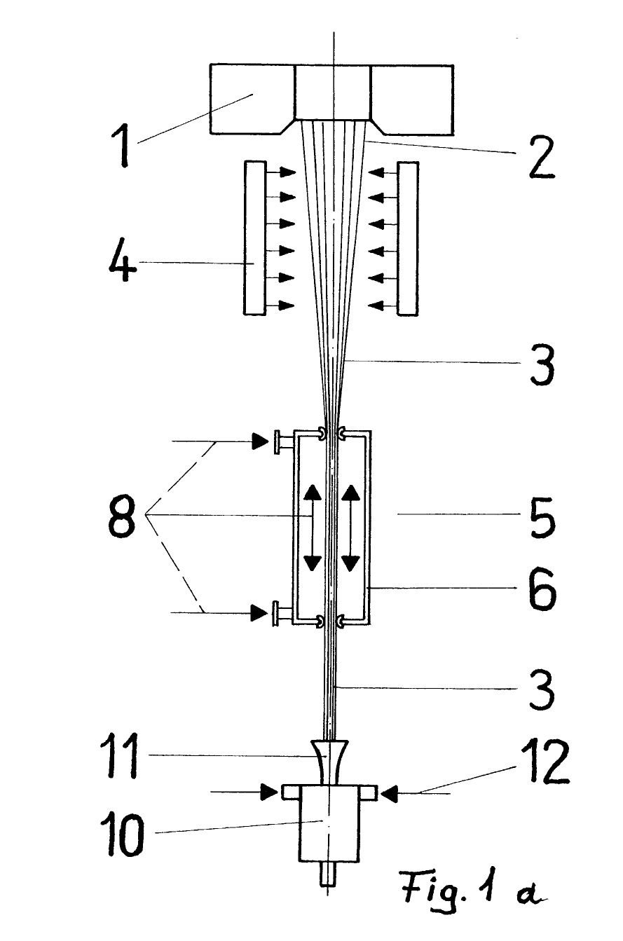

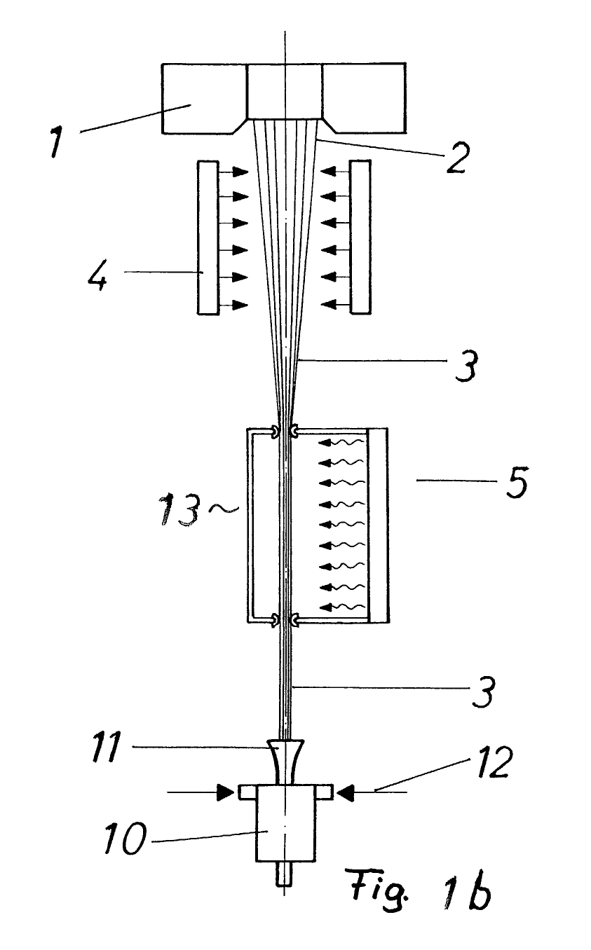

The stretching device for manufacturing stretched synthetic filaments illustrated in FIGS. 1a and 1b includes a spinning device 1 to which melted synthetic material is supplied in a known manner. A number of filaments 2 corresponding to the number of openings in the spinnerets exits via spinnerets situated in spinning device 1, and the filaments taken together form a filament bundle 3. A filament bundle usually contains up to 400 filaments. After exiting the spinneret, filaments 2 are cooled below the solidification temperature, it being possible to provide an additional cooling device 4. Crystalline and amorphous zones are thus formed in each individual filament.

Cooled filaments 2 are then transported to a heating device 5 and are bundled there, resulting in a parallel flow through heating device 5. Heating device 5 has a heating shaft 6 which is supplied with a heating medium 8, in particular steam. The direction of flow of heating medium 8 in heating shaft 6 may be oriented as that of filament bundle 3 or in counterflow thereto.

At a specified distance from heating shaft 6, drawing-off device 10 is situated which exerts a traction force on filament bundle 3. This is achieved pneumatically via a Venturi nozzle 11 which is supplied with highly pressurized air, so that the speed of sound is reached at the narrowest cross section, and the speed of sound is exceeded in the continuation of the Venturi nozzle.

Filament bundle 3 exiting drawing-off device 10 may be processed in a known manner into synthetic threads, which are cut for producing staple fibers or used for manufacturing a spun non-woven fabric. The latter is described in French Patent 74 20 254, for example.

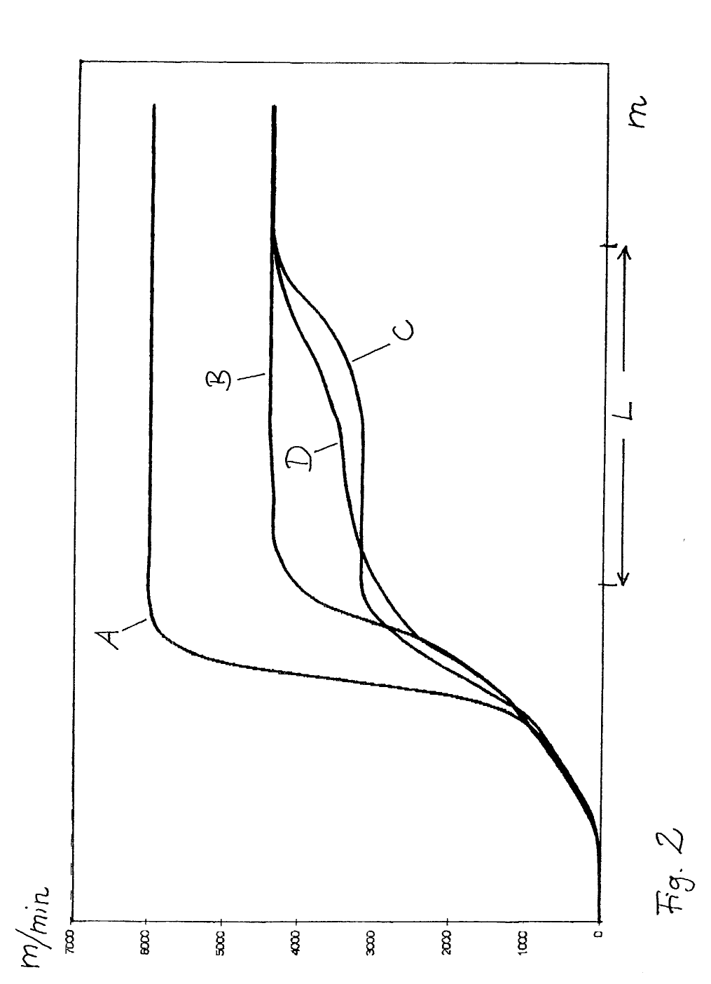

FIG. 2 shows an overview of the speed curve for the spun filaments, for various systems and methods. Under the usual conditions of direct spinning and stretching of filaments in one stage and at high speed, in this case a drawing-off speed of 6000 m/min, the filaments undergo abrupt cooling due to the very high speed gradients in the longitudinal and transverse directions (see curve A). The speed gradient along the spinning path is greater than 2×10⁴ L/s, and the cooling rate is within an order of magnitude of 26,000° C./s. These extreme conditions bring about a varying, heterogeneous structure between the sheathing and the core of the filament. Compared to the filaments after-stretched stretched in a multi-stage method, the method at hand results in a decline in certain mechanical properties.

A decrease in the speed down to a 4400 m/min drawing-off speed markedly reduces the speed gradients and the cooling rate, as may be read from curve B. However, at the same time the breaking load decreases and the breaking elongation increases.

In order to obtain an increase in the breaking load and a reduction in the breaking elongation in spite of advantageously low drawing-off speeds, two-stage mechanical methods are used which have a first region with one high speed gradient and a second region with multiple high speed gradients. This is illustrated in curve C.

The variation illustrated in curve D is achieved by using a heating device according to the present invention between the spinneret and the drawing-off device at a drawing-off speed of 4400 m/min. After-stretching of the filaments which have been heated above the solidification point takes place over a length L of heating device 5.

Table 1 shows a comparison of various test results, with and without a heating device, for different mass flow rates of polyethylene terephthalate (PET) having a melting point of 256° C. and a viscosity of 190 Pa.s at 290° C.

A stretching device having a spinning device 1 and drawing-off device 10 was used to manufacture filaments in a first test setup T.

Second test setup V differs from the first in that a heating device 5 according to the present invention was provided between spinning device 1 and drawing-off device 10 in which the filaments were heated to a temperature above the solidification temperature, which however did not reach the melting temperature.

The tests were carried out for both test setups, one having a mass flow rate of 0.9 g/min per capillary opening in the spinneret (T1, V1.1, V1.2) and the other having a mass flow rate of 0.56 g/min per capillary opening in the spinneret (T2, V2).

In comparing the essential properties of the filament produced in the first test series, it may first be concluded that the drawing-off speed of the filament in tests V1.1 and V1.2 has decreased considerably in comparison to T1. This may be explained by the fact that the frictional forces in the heating device were not completely offset by the pressure rise in the drawing-off device. Therefore, it is not possible to make a direct comparison here of the mechanical properties of two filaments produced at the same drawing-off speed according to the two test setups T, V.

However, it is noted that in spite of a reduction in the drawing-off speed from 4800 m/min to 3300 m/min the tenacity increased from 30.5 cN/Tex to 40 cN/Tex, and the elongation decreased from 72% to 55% (T1 and V1.2). Thus, for creating filaments having high tenacity it is possible to operate in a region of average drawing-off speed. An increase in the speed to 4000 m/min in the test setup having a heating device results in an additional improvement in the tenacity from 40 cN/dTex to 56 cN/dTex, and a decrease in the elongation from 56% to 40% (V1.2 compared to V1.1).

In the second test series V2, T2, a polymer/orifice mass flow rate of 0.56 g/min was set. The drawing-off speed decreased, even in the finer titer region. The tenacity improved significantly from 26 cN/Tex to 38 cN/Tex, and the elongation likewise was markedly reduced from 82% to 48%.

TABLE 1

| Test | V1.1 | V1.2 | T1 | V2 | T2 |
|---|---|---|---|---|---|
| Mass flow, polymer/orifice | 0.90 | 0.90 | 0.90 | 0.56 | 0.56 |
| (g/mn orifice) | | | | | |
| Titer | 2.2 | 2.7 | 1.9 | 1.8 | 1.3 |
| (dTex) | | | | | |
| Drawing-off speed | 4000 | 3300 | 4800 | 3100 | 4300 |
| (m/min) | | | | | |
| Tenacity | 40 | 43 | 30.5 | 38 | 26 |
| (cN/Tex) | | | | | |
| Elongation | 56 | 45 | 72 | 48 | 82 |
| (%) | | | | | |
| Splitting rate | 98 | 100 | 85 | 99 | 85 |
| (%) | | | | | |
| Thermal shrinkage | 4.0 | 4.0 | 4.5 | 5.0 | 5.5 |
| (%) (180° C., 15 min hot air) | | | | | |

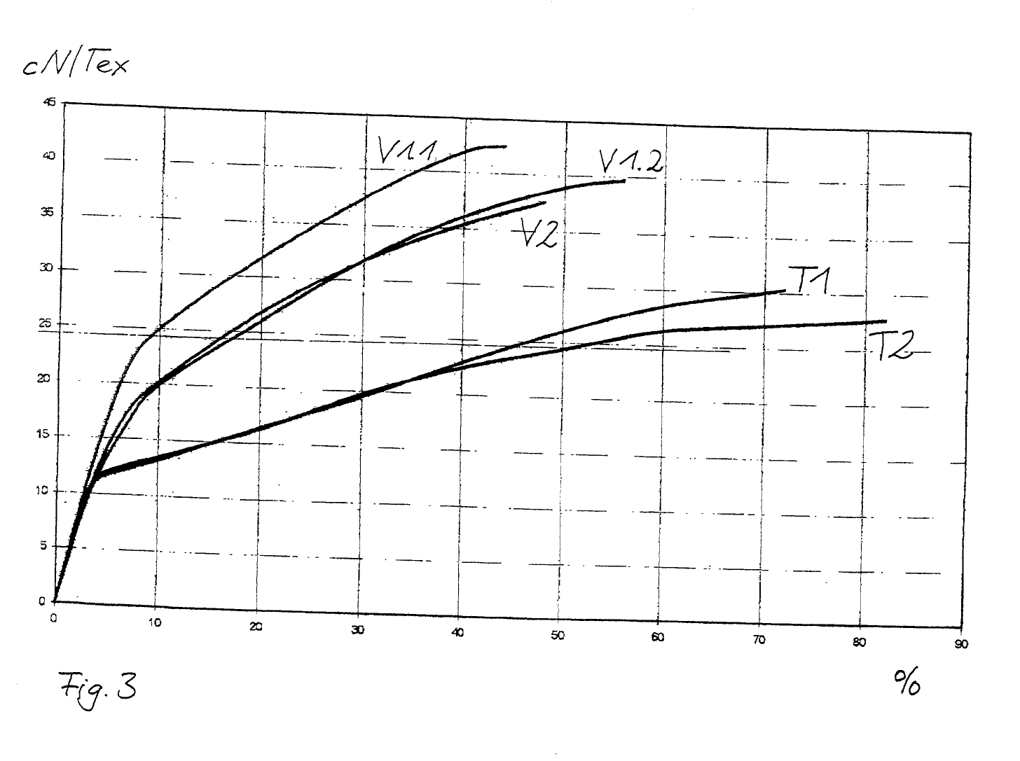

The force-elongation curve of the filaments resulting from tests T1, V1, V1.1, V1.2, T2, and V2 is presented in FIG. 3. The extraordinarily large influence of the heating device on the tenacity as well as on the elongation can be seen. Of particular importance is the significant improvement in the elongation in the region where forces are greater than 10 cN/Tex. The improved filaments are clearly able to accept a higher load without undergoing excessive elongation. This behavior is observed to a significant degree even for filaments produced at reduced drawing-off speed according to V1.2 and V2.

The filaments exiting the spinning device, which has a temperature of approximately 300° C., are cooled by blowing with air at room temperature, and the filaments are heated in the heating device to 270° C.-300° C. using a volumetric flow rate of steam between 20 m³/hr and 30 m³/hr. It is understood that the temperature of gaseous fluid 8 must be adjusted for polyolefins, depending on the respective melting temperature. The mass flow rate of gaseous fluid 8 depends, among other factors, on the quantity of filaments to be stretched, the polymer or polymers used, the drawing rate, and the pre-stretching between spinning device 1 and heating device 5.

On account of their improved mechanical properties, the filaments are particularly suited for the manufacture of non-woven fabrics, using such materials as thermoplastic synthetics, for example, polyesters such as polyethylene terephthalate (PET), polybutylene terephthalate (PBT), and polytrimethylene terephthalate (PTT); polyamides such as polyamide 6 (PA 6), polyamide 6.6 (PA 6.6), polyamide 11 (PA 11), and polyamide 4.6 (PA 4.6); or polyolefins such as polyethylene (PE), polypropylene (PP), or their copolymers. The filaments may also be manufactured from a number of various materials, using known spinning techniques.

What is claimed is:

1. A stretching device for manufacturing stretched synthetic filaments (2, 3) comprising: a spinning device (1), a pneumatic drawing-off device (10), and a heating device (5), wherein the heating device (5) is positioned between the spinning device (1) and the drawing-off device (10), and wherein the heating device (5) includes a heating medium (8) which heats the synthetic filaments (2, 3) to a temperature between their glass-transition temperature and their melting temperature.

2. The stretching device according to claim 1, wherein the heating medium (8) is supplied at a flow rate of 5 m³/hr to 50 m³/hr, creating a static gauge pressure of 0.05 bar to 1.0 bar.

3. The stretching device according to claim 1, wherein the heating device (5) is an infrared heating device (13).

4. The stretching device according to claim 1, having a static gauge pressure is 0.1 bar to 0.5 bar.

5. The stretching device according to claim 1, wherein 5 m³/hr to 50 m³/hr steam is supplied as the heating medium (8).

6. A method of manufacturing stretched synthetic filaments (2, 3) comprising: cooling melt-spun filaments (2, 3) having an individual titer greater than 1 dTex at least to the solidification temperature downstream from a spinning device (1) and stretching the filaments using a pneumatic drawing-off device (10), wherein, for the purpose of stretching, the filaments are heated in a heating device (5) to a temperature between their glass-transition temperature and their melting temperature.

7. The method according to claim 6, wherein the filaments are fed into the heating device (5) via a gaseous heated fluid (8) which is supplied at a flow rate of 20 m³/hr to 50 m³/hr, creating a static gauge pressure of 0.05 bar to 1.0 bar.

8. The method according to claim 6, wherein the heating is performed using an infrared heating device (13) which is situated at right angles to the vertically moving filaments.

9. The method according to claim 6, wherein after-stretching occurs between the heating device (5) and the drawing-off device (10) at a stretching ratio of 1.1 to 1.05.

10. The method according to claim 6, wherein the filaments are fed through the heating medium (8) at a drawing-off speed of 2000 m/min to 4700 m/min.

11. The method according to claim 7, wherein the speed of the flowing heating medium (8) when entering the heating device (5) is between 35 m/s and 50 m/s, and when leaving the heating device (5) the speed is between 70 m/s and 90 m/s.

12. The method according to claim 7, wherein the drawing-off speed of the filaments (2, 3), the quantity of energy in the heating medium, and the temperature of the heating medium (8) are adjusted so that, at the same drawing-off speed, a relative increase in the tensile strength of the after-stretched filament of at least 20% is achieved compared to a filament stretched in a single-stage process, a tensile strength of the filaments of at least 32 cN/Tex, preferably 40 cN/Tex to 50 cN/Tex, being achieved.

13. The method according to claim 12, wherein the drawing-off speed of the filaments (2, 3) and the temperature of the heating medium (8) are adjusted so that the transition from the region of elastic deformation to the region of plastic deformation does not occur until a force at least 20% higher is applied.

14. The method according to claim 13, wherein the quantity of the heating medium and the temperature of the heating medium (8) are adjusted so that a maximum hot air shrinkage of 6% (at 180° C., 15 minutes) is achieved.
